(19) United States
(12) Patent Application Publication
(10) Pub. No.: US 2025/0220565 A1
(43) Pub. Date: Jul. 3, 2025

(54) REPLACEMENT OF AN UNTRUSTED NETWORK FUNCTION

(71) Applicant: LENOVO (SINGAPORE) PTE LIMITED, Singapore (SG)

(72) Inventors: Andreas KUNZ, Ladenburg (DE); Sheeba Backia Mary BASKARAN, Friedrichsdorf (DE)

(21) Appl. No.: 18/852,218

(22) PCT Filed: Mar. 27, 2023
(86) PCT No.: PCT/IB2023/053031

§ 371 Date: Sep. 27, 2024

Related U.S. Application Data
(60) Provisional application No. 63/324,527, filed on Mar. 28, 2022.

(51) Int. Cl. H04W 48/18; H04W 60/04; H04W 76/20

(52) U.S. Cl. CPC H04W 48/18; H04W 60/04; H04W 76/20

(57) ABSTRACT

In response to a network function of a communication system, such as an Access and Mobility Function (AMF) of a wireless communication network, being determined to be an untrusted network function, the untrusted network function may be replaced without requiring participation of the untrusted network function. For example, to replace a first AMF determined to be an untrusted AMF, UE registered to the untrusted AMF may re-register with a second AMF as a result of operations performed by a Trust Surveillance Network Function, the second AMF, and a base station or Unified Data Management function, and without reliance on any operation of the untrusted AMF.

### CROSS REFERENCE TO RELATED APPLICATIONS

This application claims priority to U.S. Provisional Patent Application No. 63/324,527, filed on Mar. 28, 2022, entitled REPLACEMENT OF AN UNTRUSTED NETWORK FUNCTION, which is hereby incorporated by reference in its entirety.

### TECHNICAL FIELD

The present disclosure relates to wireless communications, and more specifically to replacement of a network function in a wireless communication system.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, including time resources (e.g., symbols, slots, subframes, frames, or the like), frequency resources (e.g., subcarriers, carriers), or combinations thereof. Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

A wireless communication system may deploy one or multiple network functions to support various wireless communication between one or more network communication devise or user communication devices. A network function may be an element within the wireless communication system supporting various interfaces and functional behavior. Examples of network functions may include an access mobility management function (AMF), an authentication server function (AUSF), a security function (e.g., a trust surveillance network function), among other examples. An AMF may perform Non-Access Stratum (NAS) ciphering & integrity protection, registration management, connection management, mobility management, access authentication and authorization, and security context management, among other functions. An AUSF may provide subscriber authentication (e.g., based on a Subscriber Identity Module (SIM)). A trust surveillance network function may verify a trust status of components in the wireless communications system and to detect when a network function is exceeding a certain threshold based on behavior that is categorized as undesired or malicious.

### SUMMARY

The present disclosure relates to methods, apparatuses, and systems that support replacing an untrusted network function associated with a wireless communication system with a trusted network function associated with the wireless communication system. The replacement of the untrusted network function with the trusted network function may occur without any involvement of the untrusted network function. As described herein, an untrusted network function may be a network function that is exceeding a threshold based on behavior that is identified as undesired or malicious (e.g., failure messages, corrupt protocol headers, amount of messages etc.). As described herein, a trusted network function may be a network function where the behavior is not exceeding such threshold. Additionally, the term “replacing” may encompass various operations actions and therefore, “replacing” may include switching, changing, choosing, re-routing, re-location and the like. By enabling the wireless communication system, including one or more network communication devices or user communication devices, or both, to support replacing the untrusted network function with the trusted network function, the wireless communication system may experience higher reliability wireless communication. Not replacing an untrusted network function may result in undesired behaviors like overcharging, service degeneration or unavailability of services and resulting contract violations due to not fulfilled service guarantees.

Some implementations of the method and apparatuses described herein may identify a first network function from a set of network functions associated with a wireless communication system; select a second network function from the set of network functions associated with the wireless communication system to replace the first network function; and migrate context of a user equipment (UE) registered with the first network function to the second network function without involvement from the first network function.

In some implementations of the method and apparatuses described herein, the first network function comprises an untrusted network function and the second network function comprises a trusted network function.

In some implementations of the method and apparatuses described herein, the first network function comprises a first Access and Mobility Management Function (AMF) and the second network function comprises a second AMF different from the first AMF.

In some implementations of the method and apparatuses described herein, to migrate the context, In some implementations of the method and apparatuses described herein, the method and apparatuses transmit, to a Unified Data Management (UDM) function, a request message to trigger the first network function to be replaced by the second network function and direct the UE to re-register with the second network function.

In some implementations of the method and apparatuses described herein, the request message comprises a first Globally Unique AMF Identifier (GUAMI) corresponding to the first network function, a second GUAMI corresponding to the second network function, or both.

In some implementations of the method and apparatuses described herein, the request message further comprises an indication to replace the first network function with the second network function.

In some implementations of the method and apparatuses described herein, to migrate the context, In some implementations of the method and apparatuses described herein, the method and apparatuses transmit, to a base station, a request message to trigger the first network function to be replaced with the second network function and provide a radio resource control (RRC) Connection Reject message to the UE, the RRC Connection Reject message indicating for the UE to re-register with the second network function, the RRC Connection Reject message comprising a second GUAMI corresponding to the second network function.

Some implementations of the method and apparatuses described herein may receive a first message indicating a first network function associated with a wireless communication system and a second network function associated with the wireless communication system to replace the first network function; identify a user equipment (UE) registered with the first network function based at least in part on the received message; and transmit a second message to the UE directing the UE to re-register with the second network function.

In some implementations of the method and apparatuses described herein, the first network function comprises an untrusted network function and the second network function comprises a trusted network function.

In some implementations of the method and apparatuses described herein, the first network function comprises a first Access and Mobility Function (AMF) and the second network function comprises a second AMF different from the first AMF.

In some implementations of the method and apparatuses described herein, the first message comprises a first Globally Unique AMF Identifier (GUAMI) corresponding to the first network function, and to identify the UE, the method and apparatuses identify the UE based on the first GUAMI.

In some implementations of the method and apparatuses described herein, the method and apparatuses generate a Default 5G Globally Unique Temporary User Equipment Identity (Default 5G-GUTI) including a second GUAMI corresponding to the second network function, wherein the second message comprises the Default 5G-GUTI.

Some implementations of the method and apparatuses described herein receive a first message indicating a first network function associated with a wireless communication system and a second network function associated with the wireless communication system to replace the first network function; identify a user equipment (UE) associated with the first network function; transmit, to the UE, a second message indicating for the UE to re-register with the second network function, the second message comprising a radio resource control (RRC) Connection Rejection message; receive, from the UE a third message to re-register with the second network function based at least in part on the transmitted second message, the third message comprising a registration request message; modify the registration request message by replacing a first identifier corresponding to the first network function with a second identifier corresponding to the second network function, or setting an indication identifying a replacement of the first network function with the second network function, or both; and transmit the modified registration request messages to the second network function.

In some implementations of the method and apparatuses described herein, the first network function comprises an untrusted network function and the second network function comprises a trusted network function.

In some implementations of the method and apparatuses described herein, the first network function comprises a first Access and Mobility Function (AMF) and the second network function comprises a second AMF.

In some implementations of the method and apparatuses described herein, to identify the UE is based at least in part on the UE having an active control plane connection to the first network function.

In some implementations of the method and apparatuses described herein, the active control plane connection comprises an active N2 connections of a Next Generation Radio Access Network (NG-RAN).

In some implementations of the method and apparatuses described herein, to modify the registration request message, the method and apparatuses replace, in a 5G Globally Unique Temporary User Equipment Identity (5G-GUTI), a first identifier corresponding to the first network function with a second identifier corresponding to the second network function.

Some implementations of the method and apparatuses described herein receive a message indicating a first network function associated with a wireless communication system and a second network function associated with the wireless communication system to replace the first network function; and initiate a registration with the second network function based at least in part on the received message.

In some implementations of the method and apparatuses described herein, the first network function comprises an untrusted network function and the second network function comprises a trusted network function.

In some implementations of the method and apparatuses described herein, the first network function comprises a first Access and Mobility Function (AMF) and the second network function comprises a second AMF.

In some implementations of the method and apparatuses described herein, the message is protected with a security key.

Some implementations of the method and apparatuses described herein receive a registration request message to register a user equipment (UE) lacking a security context at the apparatus;
determine to replace a previous registration associated with the UE based at least in part on the received registration request message; and initiate an authentication procedure with the UE.

In some implementations of the method and apparatuses described herein, the apparatus comprises an Access and Mobility Function (AMF).

In some implementations of the method and apparatuses described herein, to determine to replace the previous registration is based at least in part on an indication from the UE.

In some implementations of the method and apparatuses described herein, the method and apparatuses receive an N2 connection message of a Next Generation Radio Access Network (NG-RAN), the N2 connection message comprising the indication to replace the previous registration.

In some implementations of the method and apparatuses described herein, the previous registration is based at least in part on a Default 5G Globally Unique Temporary User Equipment Identity (5G-GUTI) included in the registration request message and corresponding to the apparatus.

### BRIEF DESCRIPTION OF THE DRAWINGS

FIG. 1 illustrates an example of a wireless communications system that supports replacement of a network function in accordance with aspects of the present disclosure.

FIG. 2 illustrates an example of a process that supports replacement of a network function in accordance with aspects of the present disclosure.

FIG. 3 illustrates an example of a signaling diagram that supports replacement of a network function in accordance with aspects of the present disclosure.

FIG. 4 illustrates another example of a process that supports replacement of a network function in accordance with aspects of the present disclosure.

FIG. 5 illustrates an example of a signaling diagram that supports replacement of a network function in accordance with aspects of the present disclosure.

FIG. 6 is a block diagram of a device that supports replacement of a network function in accordance with aspects of the present disclosure.

FIGS. 7 through 11 illustrated flowcharts of methods that support replacement of an untrusted network function with a trusted network function in accordance with aspects of the present disclosure.

### DETAILED DESCRIPTION

The principle of Zero Trust Security foresees continuous evaluation of the security and the trust of individual network functions in a network. A Trust Surveillance (TS) function is responsible to verify the current trust status in a network and to detect when a network function is exhibiting behavior that is considered undesired or malicious. In such a case the network function is then classified as untrusted by the Trust Surveillance function. The untrusted network function would then be replaced by an appropriate trusted network function.

For some specific network functions, such as the Access and Mobility Management Function (AMF), there is a need to replace the untrusted network function without any involvement of the untrusted network function. This is necessary because the untrusted node is already misbehaving and thus may not faithfully perform the requests sent to it. In the case of an AMF, for example, an untrusted AMF may not properly perform requests to move active User Equipment (UE) contexts to a trusted AMF.

Accordingly, there is a need for techniques to move active UE contexts of an untrusted AMF to a trusted AMF without the involvement of or reliance on the untrusted AMF.

In embodiments, a Trust Surveillance network function detects a trust issue of an AMF, and in response selects an appropriate trusted AMF as a replacement. The UEs having contexts in the untrusted AMF are then directed to reregister with the trusted AMF, either via a communication from the Trust Surveillance network function to a Unified Data Management (UDM) function and/or Authentication Server Function (AUSF) or via a communication from the Trust Surveillance network function to a base station.

Accordingly, UE contexts in an AMF that has become untrusted may be migrated to a trusted AMF without reliance on the untrusted AMF, and accordingly the untrusted AMF cannot prevent, interfere, or comprise the migration of the UE contexts.

Aspects of the present disclosure are described in the context of a wireless communications system. Aspects of the present disclosure are further illustrated and described with reference to device diagrams, flowcharts that relate to replacement of a network function, such as an untrusted network function, by a trusted network function, in which the replacement is performed without involvement of the untrusted network function (i.e., the network being replaced).

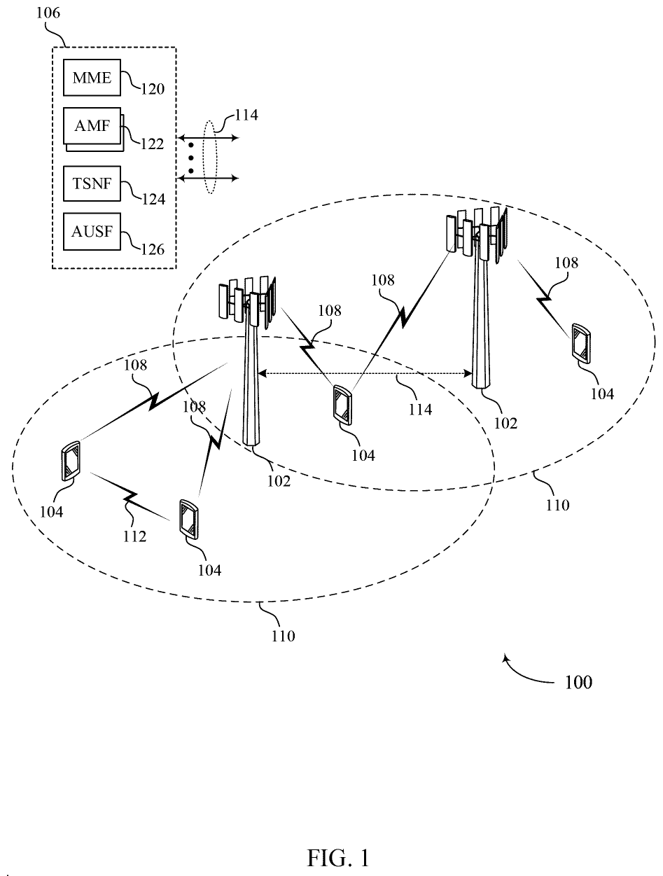

FIG. 1 illustrates an example of a wireless communications system 100 that supports replacement of a network function in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a 3^{rd} Generation Partnership Project (3GPP™) New Radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a network entity, a network communication device, a base transceiver station, an access point, a NodeB, an eNodeB (eNB), a next-generation NodeB (gNB), or other suitable terminology. A base station 102 and a UE 104 may communicate via a communication link 108, which may be a wireless or wired connection.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may comprise one or more computers and associated communication interconnects, and may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME) 120, one or more access and mobility management functions (AMFs) 122, and so on) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

The core network 106 may also provide a Trust Surveillance Network Function 124 and an Authentication Server Function (AUSF) 126. The AUSF 126 may provide subscriber authentication, (e.g., based on a Subscriber Identity Module (SIM), and in embodiments may include or be coupled to a Unified Data Management (UDM) function. The Trust Surveillance Network Function 124 may verify the trust status of components in the wireless communications system and detect when a network function is exceeding a certain threshold for behavior that is categorized as undesired or malicious.

In particular, the Trust Surveillance Network Function 124 may monitor the one or more AMFs 122 to detect when an AMF 122 may have become untrustworthy. In embodiments, the Trust Surveillance Network Function 124 may, in combination with the AUSF 126, one of the Base stations 102, or both, operate to replace an AMF 122 that has been determined to be untrustworthy (an untrusted AMF 122) with a trusted AMF 122, without the cooperation of the untrusted AMF 122.

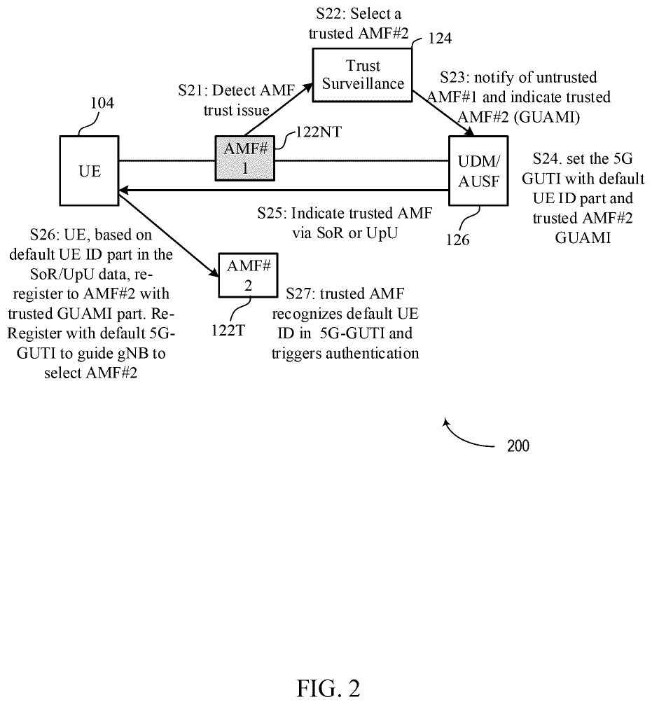

FIG. 2 illustrates a process 200 for replacing an untrusted AMF 122NT with a trusted AMF 122T without the cooperation of the untrusted AMF 122NT, in accordance with aspects of the present disclosure.

The Trust Surveillance Network Function 124 is monitoring network functions in the network. Once the Trust Surveillance Network Function 124 detects a trust issue in AMF 122NT, it selects a replacement trusted AMF 122T and provides this information to a UDM/AUSF 126. The UDM/AUSF 126 then creates a Default Globally Unique Temporary UE Identity (GUTI) with the replacement Globally Unique AMF Identifier (GUAMI) associated with the trusted AMF 122T and sends it via a protected communication to all the UEs served by the untrusted AMF 122NT. The UEs then perform a reregistration procedure with the Default GUTI which is then pointing to the replacement trusted AMF 122T. The replacement trusted AMF 122T then detects the Default GUTI and initiates a fresh primary authentication run with the UEs to create a new security context.

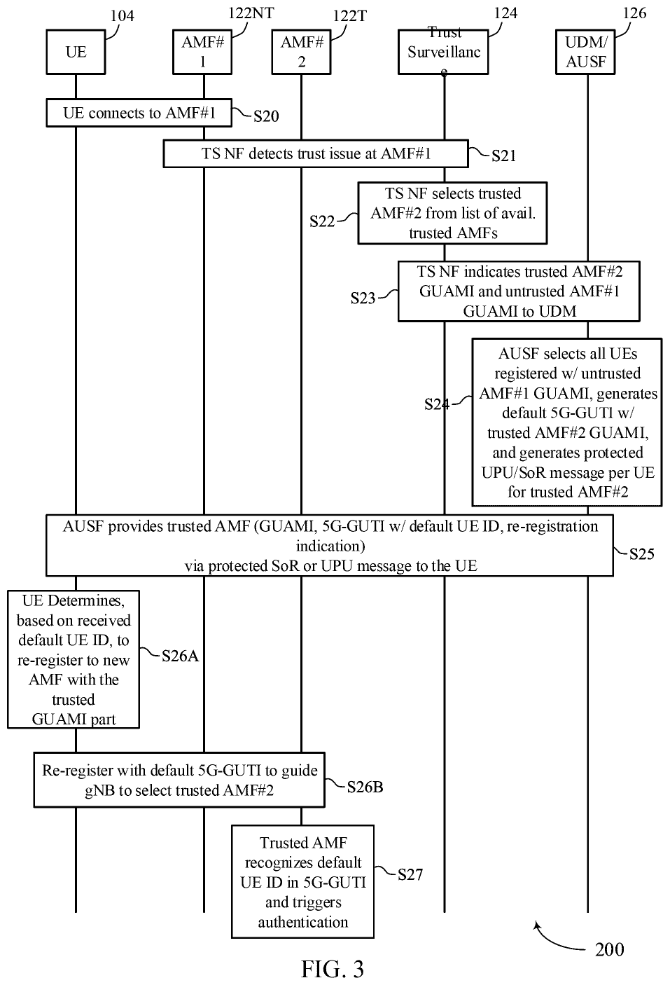

FIG. 3 illustrates transactions and operations of the process 200 of FIG. 2 in further detail, in accordance with aspects of the present disclosure. In FIG. 3, reference characters of the form S2x correspond to like labels in FIG. 2.

At step S20, the UE has an active context in the AMF 122NT, which may have been a trusted AMF at the time the context was established.

At step S21, the Trust Surveillance Network Function 124 detects that the AMF 122NT is exhibiting unexpected or undesired behavior, which behavior may be malicious. That is, the Trust Surveillance Network Function 124 detects a trust issue at the AMF 122NT based on various metrics (for example, unexpected messages, connection attempts to network functions out of the service scope of the AMF 122NT, an increase of protocol failures in communications with the AMF 122NT, and the like, or combinations thereof). In response the Trust Surveillance Network Function 124 determines that the AMF 122NT is untrusted.

In response to determining that the AMF 122NT is untrusted, at step S22 the Trust Surveillance Network Function 124 selects a suitable trusted AMF 122T to replace the untrusted AMF 122NT. The trusted AMF 122T may be selected from a list of alternative AMFs.

At step S23, the Trust Surveillance Network Function 124 indicates to the UDM/AUSF 126 that the AMF 122NT is untrusted and indicates that the trusted AMF 122T is to replace the untrusted AMF 122NT. In embodiments, the Trust Surveillance Network Function 124 may indicate the untrusted AMF 122NT using a GUAMI corresponding to the untrusted AMF 122NT, and may indicate the trusted AMF 122T using a GUAMI corresponding to the trusted AMF 122T.

In response to the indications received from the Trust Surveillance Network Function 124, at step S24 the UDM/AUSF 126 creates a Default 5G-GUTI with the GUAMI of the trusted AMF 122T. The username part of the Default 5G-GUTI may indicate the replacement in various ways and encodings.

The UDM/AUSF 126 then selects, using the GUAMI corresponding to the untrusted AMF 122NT, all registered UEs that are connected to the untrusted AMF 122NT.

The UDM/AUSF 126 then creates, for each selected UEs 104 served by the untrusted AMF 122NT, a Steering of Roaming (SoR) message. The SoR message includes at least the Default 5G-GUTI which includes the GUAMI of the replacement AMF, trusted AMF 122T. Further information may be included, for example, an indication for the UE to re-register with the Default 5G-GUTI, the GUAMI of the trusted AMF 122T, and so on. The messages are then protected according to a UE Parameter Update (UPU) or Steering of Roaming (SoR) procedure in 3GPP TS 33.501, i.e. the UDM/AUSF 126 may integrity protect the UPU/SoR message with am AUSF cryptographic key KAUSF.

At step S25, the UDM/AUSF 126 provides the respective protected UPU/SoR message with the Default 5G-GUTI to each of the selected UEs 104 served by the untrusted AMF 122NT. If available, the message includes an indication for the UE to re-register with the Default 5G-GUTI and the GUAMI of the trusted AMF 122T. The presence of the indication is interpreted by the UE as an explicit command to re-register with the Default 5G-GUTI, else, if the indication is omitted, the UE interprets the presence of the Default 5G-GUTI as an implicit command to re-register with the Default 5G-GUTI.

At step S26A, a UE 104 that received a message sent in step S25 detects based on the default username part of the Default 5G-GUTI received in the message (and, if available, based on the indication to reregister with the Default 5G-GUTI) that the UE 104 has to reregister with the Default 5G-GUTI, which points to the trusted AMF 122T.

At step S26B, the UE 104 performs a reregistration with the Default 5G-GUTI, and a base station 102 (such as a gNB) that the UE 104 performs the reregistration with selects the trusted AMF 122T based on the GUAMI includes in the Default 5G-GUTI. Note that steps S26A and S26B together correspond to S26 of FIG. 2.

At step S27, is response to being selected by the base station 102, the trusted AMF 122T detects the Default 5G-GUTI and that an AMF replacement took place. In response, the trusted AMF 122T initiates primary authentication in order to create a fresh security context for the UE 104.

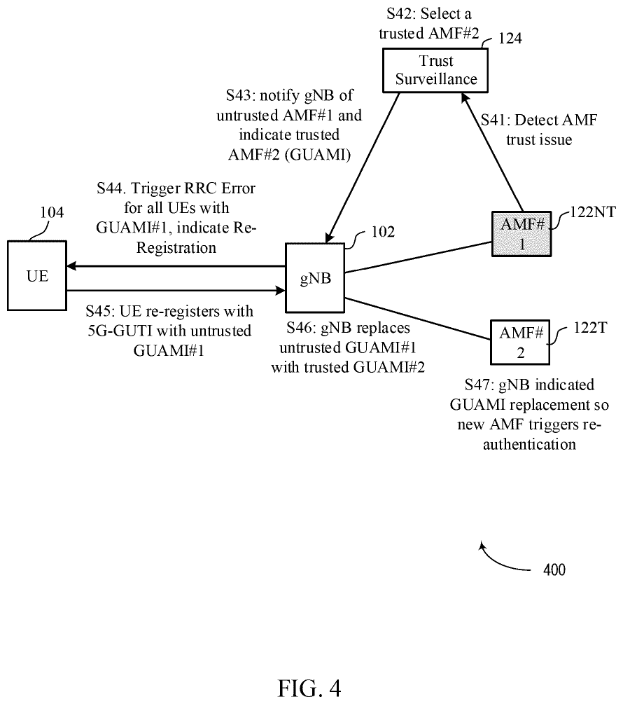

FIG. 4 illustrates a process 100 for replacing an untrusted AMF 122NT with a trusted AMF 122T without the cooperation of the untrusted AMF 122NT, in accordance with another aspect of the present disclosure.

The Trust Surveillance Network Function 124 is monitoring network functions in the network. Once the Trust Surveillance Network Function 124 detects a trust issue in AMF 122NT, it selects a replacement trusted AMF 122T and provides this information to a base station 102 (here, a gNB). The information may be provided to all the base stations 102 that have control plane interface connections (e.g., N2 connections) to the untrusted AMF 122NT. The base stations 102 perform a Radio Resource Control (RRC) Connection Reject with an indication to reregister for all UEs 104 with an active N2 connection to the untrusted AMF 122NT. The UEs 104 then perform a reregistration procedure wherein the base stations 102 replaces a GUAMI of the untrusted AMF 122NT with a GUAMI of the trusted AMF 122T in the respective 5G-GUTIs. The base stations 102 further indicate an AMF Replacement in the N2 or NAS message to the trusted AMF 122T. The trusted AMF 122T then detects the AMF Replacement and initiates a fresh primary authentication run with the UEs 104 to create new respective security contexts for the UEs 104.

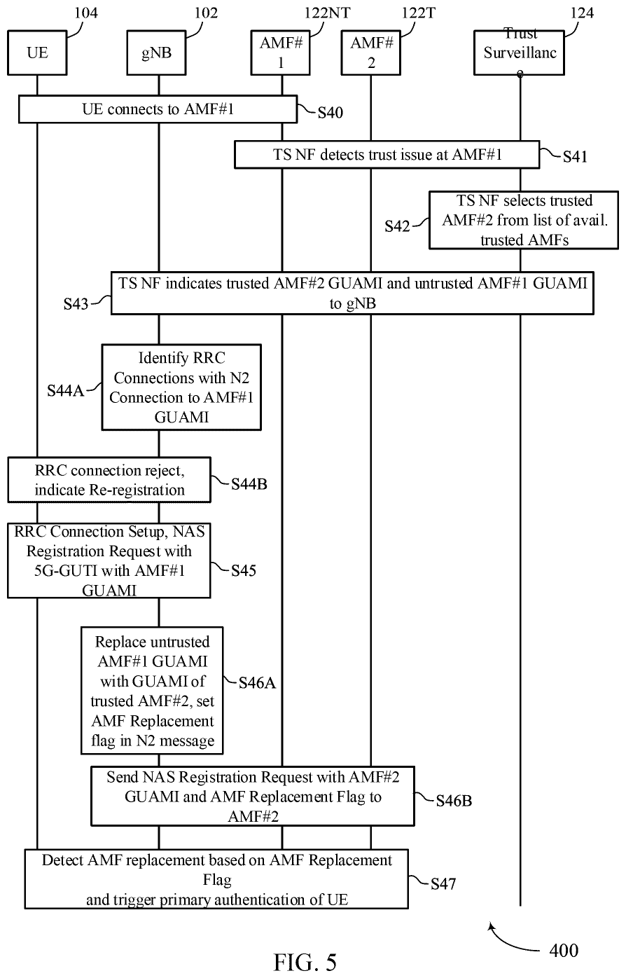

FIG. 5 illustrates transactions and operations of the process 400 of FIG. 4 in further detail, in accordance with aspects of the present disclosure. In FIG. 5, reference characters of the form S4x correspond to like labels in FIG. 4.

At step S40, the UE has an active context in the AMF 122NT, which may have been a trusted AMF at the time the context was established.

At step S41, the Trust Surveillance Network Function 124 detects that the AMF 122NT is exhibiting unexpected or undesired behavior, which behavior may be malicious. That is, the Trust Surveillance Network Function 124 detects a trust issue at the AMF 122NT based on various metrics (for example, unexpected messages, connection attempts to network functions out of the service scope of the AMF 122NT, an increase of protocol failures in communications with the AMF 122NT, and the like, or combinations thereof). In response the Trust Surveillance Network Function 124 determines that the AMF 122NT is untrusted.

In response to determining that the AMF 122NT is untrusted, at step S42 the Trust Surveillance Network Function 124 selects a suitable trusted AMF 122T to replace the untrusted AMF 122NT. The trusted AMF 122T may be selected from a list of alternative AMFs.

At step S43, the Trust Surveillance Network Function 124 determined which of the base stations 102 are affected by the loss of trust in the untrusted AMF 122NT. The affected base stations 102 may be base stations 102 with N2 connections to the untrusted AMF 122NT. The Trust Surveillance Network Function 124 then indicates to each of the affected base stations 102 that the AMF 122NT is untrusted and indicates that the trusted AMF 122T is to replace the untrusted AMF 122NT. In embodiments, the Trust Surveillance Network Function 124 may indicate the untrusted AMF 122NT using a GUAMI corresponding to the untrusted AMF 122NT, and may indicate the trusted AMF 122T using a GUAMI corresponding to the trusted AMF 122T.

In response to the indication received from the Trust Surveillance Network Function 124, at step S44A each base station 102 identifies affected RRC Connections that are mapped to the N2 connection of the untrusted AMF 122NT.

Then, at step S44B, each base station 102 rejects the respectively identified RRC Connections and signals to the affected UEs 104 to respectively perform a reregistration. This signaling may be a done using RRC Connection Reject message or any other appropriate RRC message. Note that steps S44A and S44B together correspond to S44 of FIG. 4.

At step S45, a UE 104 that received a message sent in step S44B performs a new RRC Connection Setup and sends a NAS Registration Request with the 5G-GUTI of the untrusted AMF 122NT to the base station 102.

At step S46A, the base station 102 modifies the NAS Registration Request by replacing the GUAMI of the untrusted AMF 122NT in the 5G-GUTI received from the UE 104 with the GUAMI of the trusted AMF 122T. The base station 102 sets an AMF Replacement Flag in the N2 message or in the NAS message.

At step S46B, the base station 102 selects the trusted AMF 122T based on the GUAMI received from the Trust Surveillance Network Function and sends the modified NAS Registration Request with the AMF Replacement Flag to the trusted AMF 122T.

At step S47, in response to receiving the modified NAS Registration Request, the trusted AMF 122T detects based on the AMF Replacement Flag in the NAS Registration Request or in the N2 message that an AMF replacement is taking place. In response, the trusted AMF 122T initiates primary authentication in order to create a fresh security context for the UE 104.

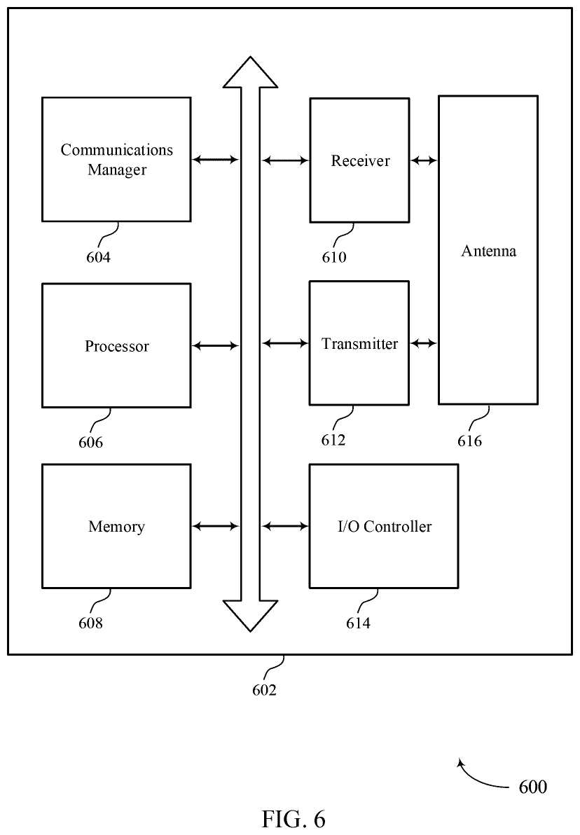

FIG. 6 illustrates a block diagram 600 of a device 602 that supports a process for replacement of an untrusted network function in accordance with aspects of the present disclosure, wherein the process relies only on resources other than the untrusted network function. The device 602 may be an example of a base station 102, a UE 104, a device that implements an Access and Mobility Function (AMF), or a device that implements a Unified Data Management (UDM) function, as described herein. The device 602 may support wireless communication with one or more base stations 102, UEs 104, other devices that implement respective network functions, or any combination thereof. The device 602 may include components for bi-directional communications including components for transmitting and receiving communications, such as a communications manager 604, a processor 606, a memory 608, a receiver 610, transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication at a first device (e.g., the device 602) in accordance with examples as disclosed herein. The communications manager 604 may be configured as or otherwise support a means for performing replacement of a network function, such as an untrusted AMF, without reliance on or involvement of the network function being replaced.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

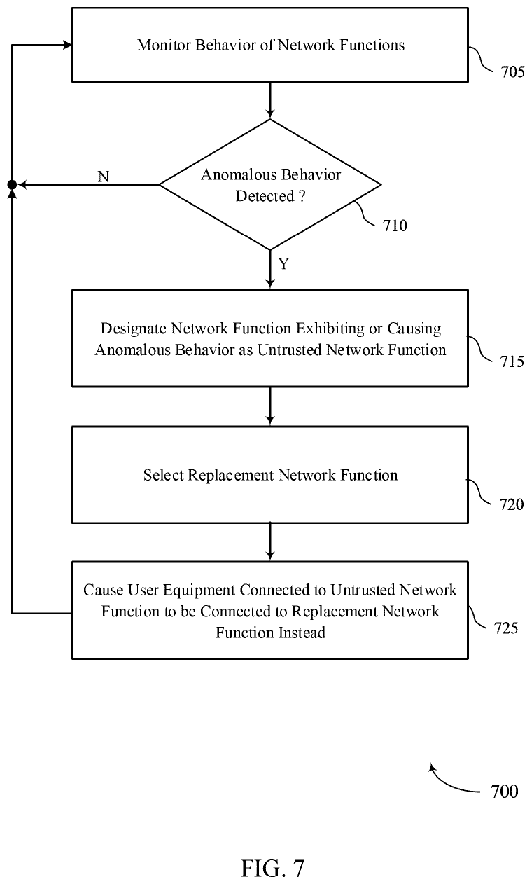

FIG. 7 is a flowchart of a method that supports replacement, in a communication system, of an untrusted network function with a trusted network function in accordance with aspects of the present disclosure. The method may be performed by a device or its components as described herein. For example, the operations of the method may be performed by a device that provides a Trust Surveillance Network Function, as described with reference to FIGS. 1 through 6. In some implementations, the device may execute a set of instructions to control the function elements of the device to perform the described functions. Additionally, or alternatively, the device may perform aspects of the described functions using special-purpose hardware.

At 705, the device may monitor the behavior of network functions in a communication network. The behavior monitored may include anomalous events, such connection attempts to network function outside the operating scope of the request originator, protocol failures, messages sent to or from a network function that are not appropriate for the network function as configured, and so on.

At 710, the device determines whether any of the network functions being monitored are behaving anomalously. For example, the device may determine that a first network function is behaving anomalously when a number of anomalous events associated with the network function exceeds a threshold value. The number of anomalous events may be, for example, a number of anomalous events during a predetermined period of time (such as in a sliding window), or a number of anomalous events since a previous point in time (such as an initiation of the network function).

When the number of anomalous events associated with the first network function exceeds the threshold value, at 710 the device proceeds to 715. When the number of anomalous events associated with the monitored network functions are less than the threshold value, at 710 the device returns to 705.

At 715, the device designates the first network function as an untrusted network function.

At 720, the device selects, from one or more trusted network functions capable of providing the services provided by the untrusted network function, a replacement network function for the untrusted network function. For example, when the untrusted network function is an Access and Mobility Function (AMF), the replacement network function will be a trusted AMF.

At 725, the device causes the untrusted network function to be replaced by the replacement network function by causing devices (such as User Equipment (UEs)) connected to the untrusted network function to connect to the replacement network function instead. This may include sending messages to one or more other entities in the communication network indicating to the other entities that the untrusted network function should be replaced by the replacement network function. The messages may also indicate that the untrusted network function is untrusted. The messages may be protected (such as by cryptography) to prevent tampering and may include information (such as a digital signature) allowing a recipient to verify the source of the message.

The entities sent messages at 725 may include one or more Unified Data Management functions, one or more base stations, or both. The messages are configured to cause the entities to identify equipment (such as UEs) using or connected to the untrusted network function and cause that equipment to use or connect to the replacement network function instead.

The operations 705 through 725 of the device may be performed in accordance with examples as described herein. In some implementations, aspects of the operations may be performed by a device as described with reference to FIG. 6.

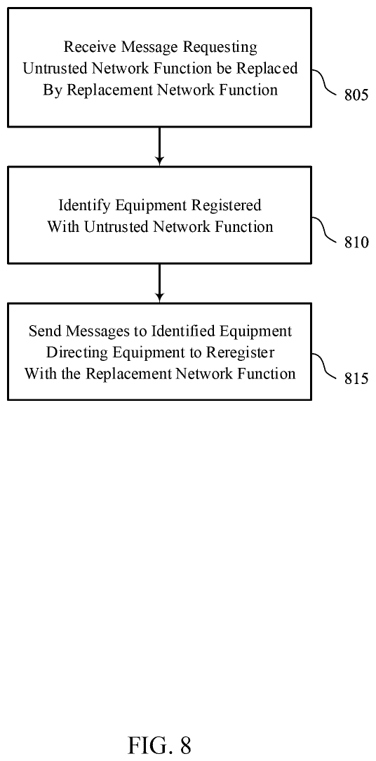

FIG. 8 is a flowchart of a method that supports replacement, in a communication system, of an untrusted network function with a trusted network function in accordance with aspects of the present disclosure. The operations of the method may be implemented using a device or its components as described herein. For example, the operations of the method may be performed, for example, by a UDM such as may be associated with an AUSF 126 and provided by one or more computers of the core network 106, as described with reference to FIGS. 1 through 6, but embodiments are not limited thereto. In some implementations, a device performing the method may execute a set of instructions to control the function elements of the device to perform the described functions, which instructions may be stored in non-transitory computer-readable media. Additionally, or alternatively, the device may perform aspects of the described functions using special-purpose hardware.

At 805, the device may receive a message requesting that an untrusted network function be replaced by replacement network function. The device may verify the authenticity and integrity of the message; for example, the device may verify, based on information such as a digital signature included in the message, that the message is from an appropriate Trust Surveillance Network Function, that the message has not been tampered with in transit, or both.

At 810, the device identifies the equipment connected to and/or using the untrusted network function. For example, when the untrusted network function is an AMF, the device may identify the UEs registered with the untrusted network function.

At 815, the device sends respective messages to the identified equipment directing the equipment to use the replacement network function. For example, when the untrusted network function and the replacement network function are AMFs, the device sends respective messages to the identified equipment directing the equipment to reregister with the replacement network function. The messages may be sent protected (such as by cryptography). The messages may be UE Parameter Update (UPU) or Steering of Roaming (SoR) messages in accordance with 3GPP TS 33.501, i.e., the AUSF may integrity protect the UPU/SoR message with the key KAUSF.

In embodiments, wherein the replacement network function is an AMF, the messages each include a Default Globally Unique Temporary UE Identity (GUTI) with a replacement Globally Unique AMF Identifier (GUAMI) corresponding to the replacement network function. The messages direct the respective equipment they are sent to perform a reregistration procedure using the Default GUTI.

The operations 805 through 815 of the device may be performed in accordance with examples as described herein. In some implementations, aspects of the operations may be performed by a device as described with reference to FIG. 6.

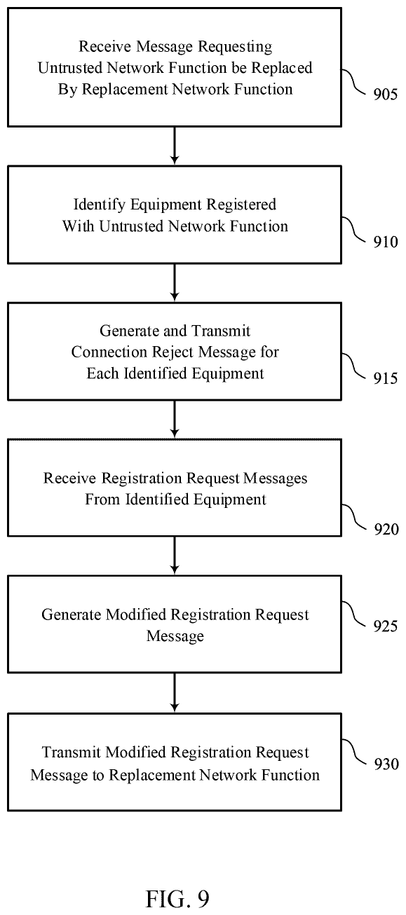

FIG. 9 is a flowchart of a method that supports replacement, in a communication system, of an untrusted network function with a trusted network function in accordance with aspects of the present disclosure. The operations of the method may be implemented using a device or its components as described herein. For example, the operations of the method may be performed, for example, by a base station 102, as described with reference to FIGS. 1 through 6, but embodiments are not limited thereto. In some implementations, a device performing the method may execute a set of instructions to control the function elements of the device to perform the described functions, which instructions may be stored in non-transitory computer-readable media. Additionally, or alternatively, the device may perform aspects of the described functions using special-purpose hardware.

At 905, the device may receive a message requesting that an untrusted network function be replaced by replacement network function. The device may verify the authenticity and integrity of the message; for example, the device may verify, based on information such as a digital signature included in the message, that the message is from an appropriate Trust Surveillance Network Function, that the message has not been tampered with in transit, or both.

At 910, the device identifies the equipment connected to the untrusted network function. For example, when the untrusted network function is an AMF, the device may identify UEs having control plane connections (for example, 5G N2 connections) with the untrusted network function.

At 915, the device identifies the RRC Connections corresponding to the control plane connections (such as the N2 connections) between the equipment and the untrusted network function. The process then generates respective rejection messages (for example, RRC Connection Reject messages) for the identified RRC Connections. The device then transmits the rejection messages to the equipment connected to the untrusted network function, respectively. The rejection messages are configured to cause the equipment receiving them to generate respective new registration requests.

At 920, the device receives registration request messages from the equipment to which the rejection requests were sent. The registration request messages may include an identifier corresponding to the untrusted network function, and may indicate that the equipment is to be registered with the untrusted network function.

At 925, the device creates respective modified registration request messages based on the received registration request messages by replacing identifiers corresponding to the untrusted network function in the registration request message with identifiers corresponding to the replacement network function. For example, when the untrusted network function is an AMF, the device may replace on or more GUAMI corresponding to the untrusted network function in the 5G-GUTI of the registration request messages with a GUAMI corresponding to the replacement network function. The device may also set a replacement flag in the modified registration request messages, for example, an AMF Replacement Flag. In embodiments, the modified registration request messages may be N2 messages, NAS messages, or a combination thereof.

At 930, the device transmits the modified registration request messages to the replacement network function. In embodiments wherein the replacement network function is an AMF, the modified registration request messages are configured to cause the replacement network function to detect that an AMF replacement is in process and in response initiate a primary authentication with the equipment that sent the registration request messages in order to create respective fresh security contexts for each of the equipment.

The operations 905 through 930 of the device may be performed in accordance with examples as described herein. In some implementations, aspects of the operations may be performed by a device as described with reference to FIG. 6.

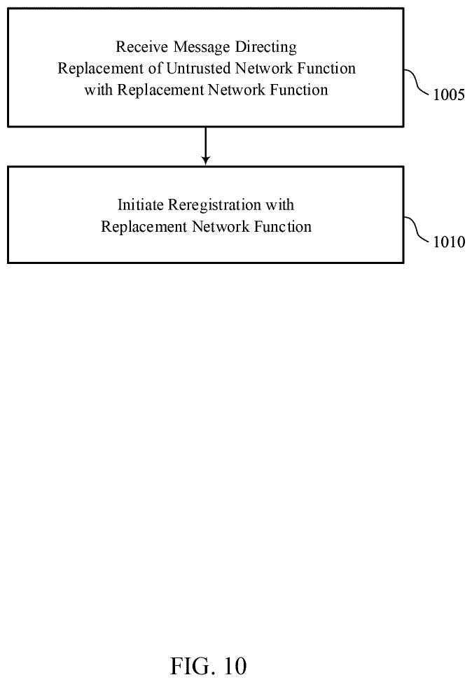

FIG. 10 is a flowchart of a method that supports replacement, in a communication system, of an untrusted network function with a trusted network function in accordance with aspects of the present disclosure. The operations of the method may be implemented using a device or its components as described herein. For example, the operations of the method may be performed, for example, by a UE 102, as described with reference to FIGS. 1 through 6, but embodiments are not limited thereto. In some implementations, a device performing the method may execute a set of instructions to control the function elements of the device to perform the described functions, which instructions may be stored in non-transitory computer-readable media. Additionally, or alternatively, the device may perform aspects of the described functions using special-purpose hardware.

At 1005, the device may receive a message directing the process to replace its current registration with a network function (which may be an untrusted network function) with a registration with a replacement network function. The message may be, for example, a message sent at step 815 of a device of FIG. 8 performed by a Unified Data management (UDM) function. In embodiments the network function being replaced (e.g., the untrusted network function) and the replacement network function are each AMFs.

In an embodiment, the message received by the device is a protected UE Parameter Update (UPU) or Steering of Roaming (SoR) message, the replacement network function is an AMF, and the message received by the device includes a Default 5G-GUTI corresponding to the replacement network function and indicates that a re-registration is requested, where the re-registration is to be performed with the replacement network function.

In response to receiving the message and determining, based on the message, to perform re-registration, at 1010 the device initiates a re-registration process with the replacement network function by sending a re-registration request to the replacement network function.

The operations 1005 and 1010 of the device may be performed in accordance with examples as described herein. In some implementations, aspects of the operations may be performed by a device as described with reference to FIG. 6.

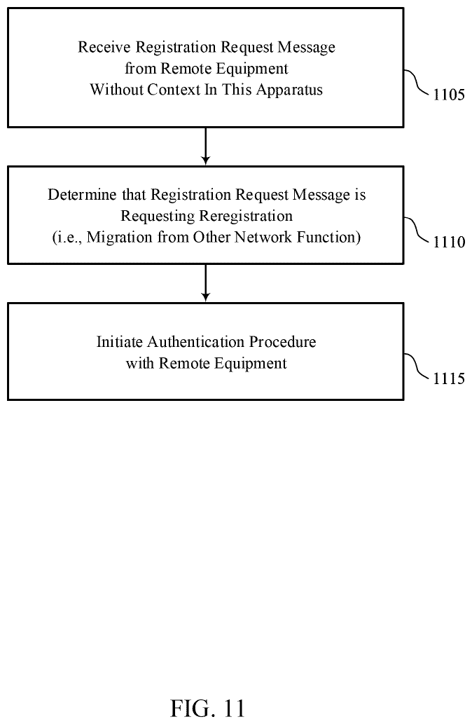

FIG. 11 is a flowchart of a method that supports replacement, in a communication system, of an untrusted network function with a trusted network function in accordance with aspects of the present disclosure. The operations of the method may be implemented using a device or its components as described herein. For example, the operations of the method may be performed, for example, by an AMF 122 provided by one or more computers of the core network 106, as described with reference to FIGS. 1 through 6, but embodiments are not limited thereto. In some implementations, a device performing the method may execute a set of instructions to control the function elements of the device to perform the described functions, which instructions may be stored in non-transitory computer-readable media. Additionally, or alternatively, the device may perform aspects of the described functions using special-purpose hardware.

At 1105, the device may receive a message requesting registration from equipment, such as User Equipment, that is not registered (for example, that does not have a security context) with the device. In embodiments, the message is included in an N2 connection message of a Next Generation Radio Access Network (NG-RAN).

At 1110, the device determines that the message is requesting a re-registration. In embodiments, determining that the message is requesting a re-registration may be based on an explicit indication included in the message that a re-registration is being requested. In embodiments, determining that the message is requesting a re-registration may be based on a Default 5G Globally Unique Temporary User Equipment Identity (5G-GUTI) included in the message and corresponding to the device.

In response to determining that that message is requesting a re-registration, at 1115 the device initiates an authentication procedure with the equipment for which the re-registration is being requested.

The operations 1105 through 1115 of the device may be performed in accordance with examples as described herein. In some implementations, aspects of the operations may be performed by a device as described with reference to FIG. 6.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
identify a first network function from a set of network functions associated with a wireless communication system;
select a second network function from the set of network functions associated with the wireless communication system to replace the first network function; and
migrate context of a user equipment (UE) registered with the first network function to the second network function without involvement from the first network function.

2. The apparatus of claim 1, wherein the first network function comprises an untrusted network function and the second network function comprises a trusted network function.

3. The apparatus of claim 1, wherein the first network function comprises a first Access and Mobility Management Function (AMF) and the second network function comprises a second AMF different from the first AMF.

4. The apparatus of claim 3, wherein, to migrate the context, the at least one processor is further configured to cause the apparatus to:
transmit, to a Unified Data Management (UDM) function, a request message to trigger the first network function to be replaced by the second network function and direct the UE to re-register with the second network function.

5. The apparatus of claim 4, wherein the request message comprises a first Globally Unique AMF Identifier (GUAMI) corresponding to the first network function, a second GUAMI corresponding to the second network function, or both.

6. The apparatus of claim 4, wherein the request message further comprises an indication to replace the first network function with the second network function.

7. The apparatus of claim 1, wherein, to migrate the context, the at least one processor is further configured to cause the apparatus to:
transmit, to a base station, a request message to trigger the first network function to be replaced with the second network function and provide a radio resource control (RRC) Connection Reject message to the UE, the RRC Connection Reject message indicating for the UE to re-register with the second network function, the RRC Connection Reject message comprising a second GUAMI corresponding to the second network function.

8. An apparatus for wireless communication, comprising:
at least one memory; and
at least one processor coupled with the at least one memory and configured to cause the apparatus to:
receive a first message indicating a first network function associated with a wireless communication system and a second network function associated with the wireless communication system to replace the first network function;
identify a user equipment (UE) registered with the first network function based at least in part on the received message; and
transmit a second message to the UE directing the UE to re-register with the second network function.

9. The apparatus of claim 8, wherein the first network function comprises an untrusted network function and the second network function comprises a trusted network function.

10. The apparatus of claim 8, wherein the first network function comprises a first Access and Mobility Function (AMF) and the second network function comprises a second AMF different from the first AMF.

11. The apparatus of claim 10, wherein the first message comprises a first Globally Unique AMF Identifier (GUAMI) corresponding to the first network function, and wherein, to identify the UE, the at least one processor is further configured to cause the apparatus to:
identify the UE based on the first GUAMI.

12. The apparatus of claim 11, wherein the at least one processor is further configured to cause the apparatus to:
generate a Default 5G Globally Unique Temporary User Equipment Identity (Default 5G-GUTI) including a second GUAMI corresponding to the second network function, wherein the second message comprises the Default 5G-GUTI.

13. An apparatus for wireless communication, comprising:
at least one memory; and
at least one processor coupled with the at least one memory and configured to cause the apparatus to:
receive a first message indicating a first network function associated with a wireless communication system and a second network function associated with the wireless communication system to replace the first network function;
identify a user equipment (UE) associated with the first network function;
transmit, to the UE, a second message indicating for the UE to re-register with the second network function, the second message comprising a radio resource control (RRC) Connection Rejection message;
receive, from the UE a third message to re-register with the second network function based at least in part on the transmitted second message, the third message comprising a registration request message;
modify the registration request message by replacing a first identifier corresponding to the first network function with a second identifier corresponding to the second network function, or setting an indication identifying a replacement of the first network function with the second network function, or both; and
transmit the modified registration request messages to the second network function.

14. The apparatus of claim 13, wherein the first network function comprises an untrusted network function and the second network function comprises a trusted network function.

15. The apparatus of claim 13, wherein the first network function comprises a first Access and Mobility Function (AMF) and the second network function comprises a second AMF.

16. The apparatus of claim 13, wherein to identify the UE is based at least in part on the UE having an active control plane connection to the first network function.

17. The apparatus of claim 16, wherein the active control plane connection comprises an active N2 connections of a Next Generation Radio Access Network (NG-RAN).

18. The apparatus of claim 13, wherein, to modify the registration request message, the at least one processor is further configured to cause the apparatus to:
replace, in a 5G Globally Unique Temporary User Equipment Identity (5G-GUTI), a first identifier corresponding to the first network function with a second identifier corresponding to the second network function.

19. A processor for wireless communication, comprising:
at least one controller coupled with the at least one memory and configured to cause the processor to:
identify a first network function from a set of network functions associated with a wireless communication system;
select a second network function from the set of network functions associated with the wireless communication system to replace the first network function; and
migrate context of a user equipment (UE) registered with the first network function to the second network function without involvement from the first network function.

20. The processor of claim 19, wherein the first network function comprises an untrusted network function and the second network function comprises a trusted network function.
